(19) United States
(12) Patent Application Publication
(10) Pub. No.: US 2005/0102652 A1
(43) Pub. Date: May 12, 2005

(54) System and method for building software suite

(75) Inventors: Jeffrey Tay Sulm, Sunnyvale, CA (US); Victor Glenn Reha, Fremont, CA (US); Scott Avery Patton, Escondido, CA (US); Vijayanand Muralidhar Kallianpur, Sunnyvale, CA (US)

Correspondence Address: ROGITZ & ASSOCIATES, 750 B STREET, SUITE 3120, SAN DIEGO, CA, 92101, US

(73) Assignees: Sony Corporation; Sony Electronics Inc.

(21) Appl. No.: 10/964,899

(22) Filed: Oct. 13, 2004

Related U.S. Application Data
(60) Provisional application No. 60/518,285, filed on Nov. 7, 2003.

(51) Int. Cl. G06F 9/44; G06F 9/45

(52) U.S. Cl. 717/115; 717/136

(57) ABSTRACT

The present invention provides an XML-based programming language, toolkit, and development environment that can be readily used and understood without the need for formal software programming skills to assemble a complete software suite for a computer.

### RELATED APPLICATIONS

This application claims priority from U.S. provisional patent application Ser. No. 60/518,285, filed Nov. 7, 2003.

### I. FIELD OF THE INVENTION

The present invention relates generally to personal computers.

### II. BACKGROUND OF THE INVENTION

Personal computers such as Sony's VAIO® computer contain a set of custom software components created to specification for each project build. In other words, some computers must have a first suite of software, e.g., a word processor, plus audio-video software, whereas another group of computers might be specified to have a second, different suite of software, to provide more choices to buyers. Here, “software suite” means a complete and total set of software for a computer, as well as component releases to, e.g., factories and testing teams, which components are put together as part of an overall project release.

Creating each custom suite requires many steps involving multiple and disjoint programs. Heretofore, in assembling the various programs of a suite, engineers had to manually locate and copy desired programs from a central database or databases onto, e.g., a disk for loading the software onto the computer. This takes time, and requires manual intervention to build a newly specified suite from scratch. Moreover, errors and inconsistencies inevitably creep into such “builds”, since the builds are not automated.

As critically recognized here, it is accordingly desirable to provide an automated way to assemble a software suite for a group of computers. As further recognized herein, however, assemblers may not have expertise in programming languages such as C++. Accordingly, the present invention recognizes a need to provide an automated way to assemble a software suite without requiring formal programming knowledge.

### SUMMARY OF THE INVENTION

A method for assembling a software package for a computer includes presenting XML constructs to a user, and allowing the user to construct an XML script using the constructs, the script defining contents of the software package. The method also includes parsing the script to render C++ software code and executing the C++ software code to automatically assemble the contents into the software package.

In preferred embodiments, the constructs are classes in an object-oriented programming environment. The classes can be presented to the user in a class window on a computer display for selection thereof by a user. During execution the user can be prompted for information relating to, e.g., an identification of the software package.

In another aspect, a system for automatically assembling at least two software applications into a package for loading thereof onto a computer includes hierarchical object-oriented means for identifying the applications in a script. The system further includes means for parsing the script into executable code. Means are provided for executing the code to automatically assemble the package.

In yet another aspect, a software system includes a model component that contains object-oriented application programming interfaces (API) which are useful for generating a list of software applications. A controller component communicates with the model component and contains a parser to parse the list into code for execution thereof to automatically assemble the applications into a package. A view component communicates with the controller component to present object classes to a user for use thereof in generating the list.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is a block diagram of the software architecture;

FIG. 3 is a flow chart of the general logic of the invention;

FIG. 4 is a schematic diagram showing a hierarchical diagram of the XML script; and

FIG. 5 is a screen shot showing the user display.

### DETAILED DESCRIPTION OF THE PREFERRED EMBODIMENT

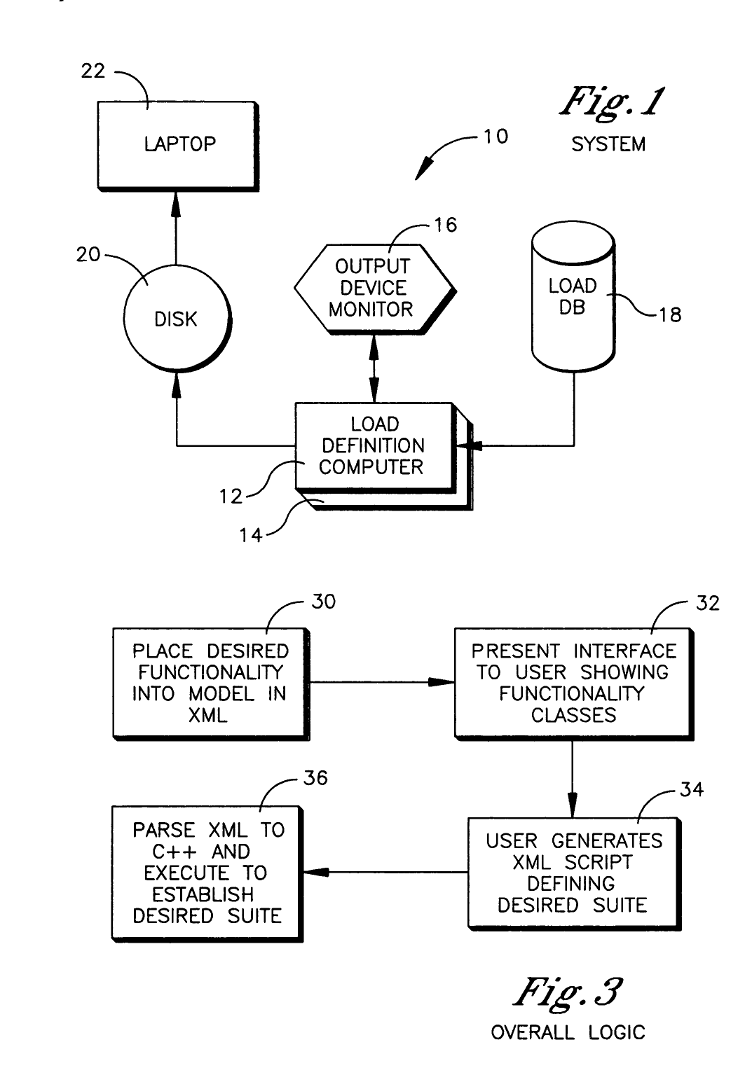

Referring initially to FIG. 1, a system is shown, generally designated 10, that can include a load definition computer 12 having one or more input devices 14 such as mice, keyboards, and the like and one or more output devices 16 such as computer monitors, printers, networks, and the like. The load computer 12 communicates with one or more data sources of software applications, such as a load database 18, to assemble applications into a suite or package that can be copied onto, e.g., an optical disk 20 for loading the software applications onto a target computer such as laptop computer 22 that may be, e.g., a Sony VAIO® computer.

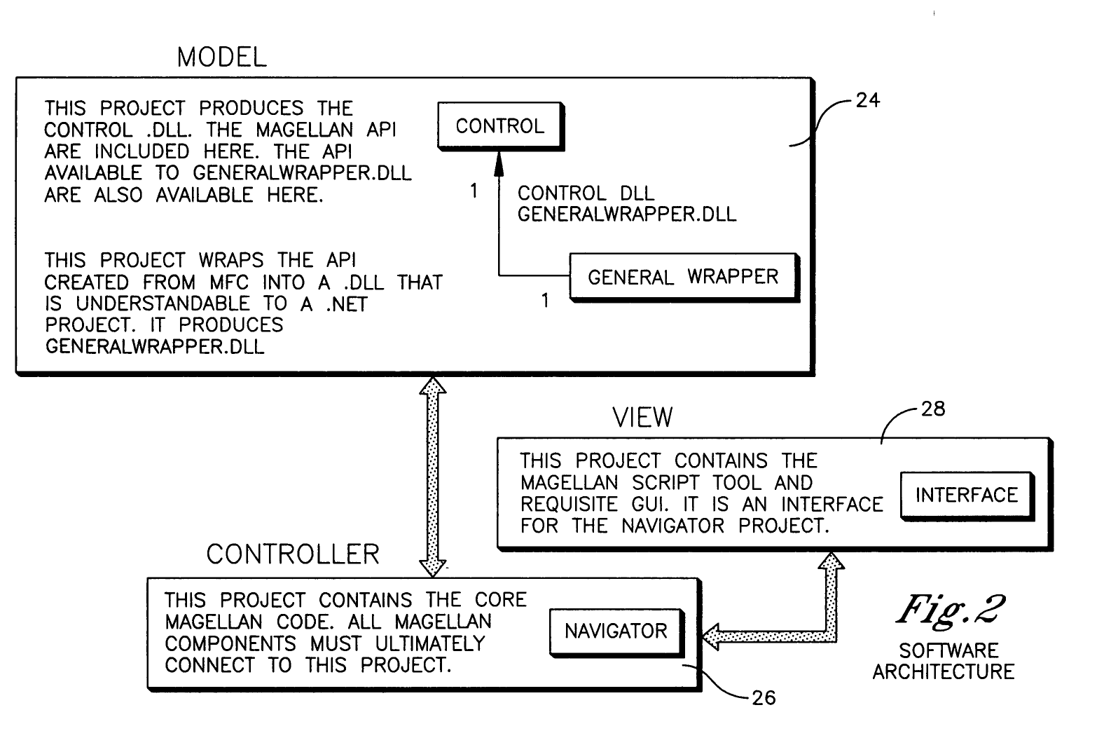

FIG. 2 shows the architecture of the software that can be executed by the load computer 12 and FIG. 3 shows the major functionality of the architecture in non-limiting flow chart format. As shown in FIG. 2, the present software may include a model component 24, a controller component 26, and a view component 28. The model component 24 contains the system application programming interface (API), preferably XML object-oriented constructs that are useful for generating a list of software applications. Thus, the API is a set of functions providing common Windows commands for program automation. The model component 24 essentially is a toolkit and an information repository which contains functions ranging from file manipulation and program execution to message display and access to the database 18.

With more specificity, the model component 24 creates a dynamic link library (DLL) file that may be understandable by Microsoft's “.NET” system in accordance with disclosure below. The model component 24 is also a repository for all XML object classes that can be selected by a user to obtain an application. Further, the model component 24 can include a control portion that has an adapter for general wrapper functions so that primitive C++ data type constructs such as “int” and “char*” are converted to Object* and String* respectively. It may also have a settings class that can be used to log the result of any command execution. This can actually be implemented by a C++ function within a class. Each API command can be a function within a single class, or can be implemented as an individual class.

The controller module 26 contains all the business logic behind the system language constructs including variable declaration and conditional statements, and it represents a parser to parse the list of applications received from the user into code for execution thereof to automatically assemble the applications into a package. To this end, the controller module 26 contains minimal coupling between both the View component 28 and the Model component 24 and provides a clear separation between the two. The controller module 26 does not need recompilation if the code changes to either of the other two components.

The view module 28 is the user interface that allows access to the Model component 24 through the controller component 26 to present object classes to a user for use thereof in generating a list or script that defines the applications to be assembled into a package. There can be two views, one used simply for program execution and debugging that can be run from a command line and a second which is a user interface used for creation, editing, and execution of system scripts. Both can receive input from an XML script or additionally through API selection within the interface.

FIG. 3 shows the overall logic embodied in the system 10. Commencing at block 30, the desired functionality in, e.g., XML-based object classes is placed into the model component 24. At block 32 the view component 28 is invoked to present to the user on, e.g., the monitor 16 shown in FIG. 1, the functionality classes discussed further below. At block 34 the user can select various classes to generate a script or list of applications that are to be assembled into a package or suite of software. Once complete, the logic can move to block 36 to execute the script by parsing the XML into executable code such as C++ and then executing the code to automatically retrieve and assemble into a package the applications identified in the script, in accordance with instructions (e.g., locations where certain applications may be found) that are contained in the script. As part of the execution, the user can be prompted for variable names and values and other information, e.g., software package name, etc.

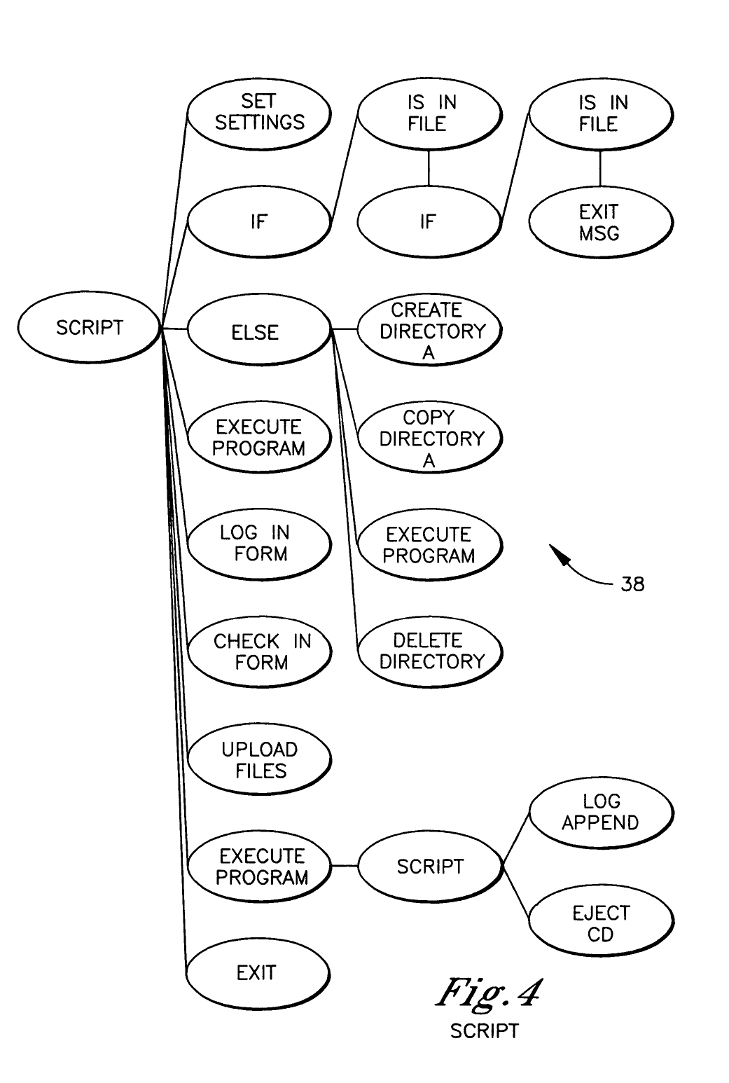

FIG. 4 shows that a script 38 generated in accordance with the above principles may be hierarchical and that consequently is treated as a hierarchical sequence of commands that are put together to form an executable program. All commands within the script advantageously can be validated with a master file of all possible commands called a Document Type Definition or DTD. By validating all commands in the XML script against the DTD before execution, the syntax is guaranteed to be correct.

As mentioned above, XML parsing into, e.g., C++ is done within the controller component 26, which handles all system language constructs. In some embodiments, script validation may be handled using a Microsoft .net system API class XMLValidatingReader, which reads XML syntax into memory one node at a time from beginning to end for validation. The actual parsing can be done using the .NET API class XPathNavigator, which uses the W3C Document Object Model or DOM [3]. Unlike the XMLTextReader, which allows forward-only parsing of XML code, DOM also allows backwards navigation. For most basic system commands, forward-only parsing is sufficient, but with advanced commands that require either conditional statements or looping, backwards parsing is also required, implicating DOM-style parsing and holding the entire code in memory.

Accordingly two types of commands, basic and advanced, may be provided. Basic commands can be used as-is from the model component 24. They may be independent of any language constructs and in fact make up most of the system API. Advanced commands, on the other hand, require additional XML parsing that may require invoking the same command multiple times. Additionally, some advanced commands such as conditional and looping statements allow nested commands. The hierarchical structure of the XML script 38 shown in FIG. 4 generally resembles a tree. Depending on the script layout the structure can be either low depth and represent one or more shrubs or high depth and represent a tree or forest. Indeed, FIG. 4 illustrates a nested capability that applies to conditional statements as well as to the XML scripts themselves. The diagram in FIG. 4 is presented in the same way it would appear in the script, and is read starting from left to right and top to bottom.

In some embodiments, to keep track of forward and backward navigation through nested commands, the depth and the current node must be known. During script execution, the return values may be recorded to determine the desired path. Undesired paths are discarded. This done by recording information in a set of stacks. The current pointer to a node moves deeper into the tree by parsing a conditional statement. The current depth after executing the conditional statement is pushed on the stack. As the pointer either moves deeper through nested conditional statements or shallower after completion the current depth is either pushed or popped from the stack respectively. Additionally, there are similar stacks to keep track of the return values per conditional. Altogether there may be four stacks for conditional statements, one to keep track of the depth and one to keep track of the return value for both If and Else statements. By comparing the value of the current node with the current values in the stacks the system 10 is able to understand even the most complex nested structures.

The present invention understands that two situations can arise where class structure must be known. The first is required by the user interface to display the names and parameters of all system API commands. The second is required by the controller module 26, which dynamically interprets system API command parameters to pass input and invoke each command during execution.

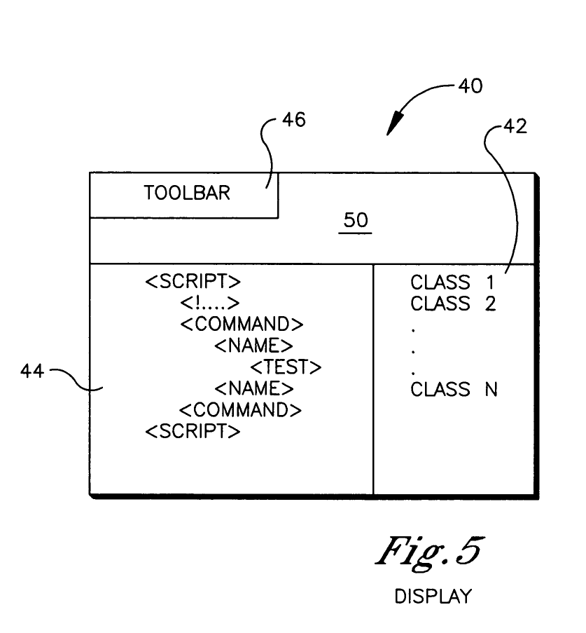

FIG. 5 shows an exemplary user interface 40 in which a list 42 of system API (essentially, functionality classes) is presented in the right pane and the parameters to an example message box command on a bottom pane 44. The parameters to other commands can also be displayed in the bottom pane by scrolling the right pane up or down. A toolbar 46 also may be advantageously provided. A main pane 50 can also be provided.

Each system API command need not require a separate parsing function within the controller 26 to handle the varying number of parameters per command, but rather a universal parsing function that uses the NET API may be shared to dynamically interpret and invoke system API commands. This is made possible through object-oriented component concepts called introspection and dynamic invocation. Input taken from the XML script is passed dynamically to the system API command for dynamic invocation. This means that the input, XML script, can change without needing to recompile the controller component 26. Ordinarily, without applying these concepts the parameter values would be fixed for static invocation through a conventional application. Only advanced commands require explicit, individual parsing functions.

The .NET internal procedure calls have been mentioned above. The system API through either direct or indirect references is entirely contained within the model component 24. All API commands that are not contained directly within the model component 24 are required to have wrapper functions that direct the controller component 26 to their respective locations. In some cases, many nested wrapper functions may be required that reuse code and programming effort that already exists with little or no modification. In some embodiments the language-independent code reuse can be facilitated by Microsoft's Component Object Model (COM).

In non-limiting embodiments no user interface is present that requires adding logic. Once a component is registered it is available for use as if the code were directly within the relevant class in the model component 24. Data entry into the database 18 shown in FIG. 1 may be facilitated by a COM object having a user interface which contains GUI fields specific to its task. It can be a single function piece, but by itself is not a complete application, but rather is an object, e.g., a piece of an application containing user interaction and back end functionality. Because it cannot be used as is it must be placed in a container before use. The present system 10 provides such a container called ControlForm. This class is basically a window with two buttons, OK and Cancel. The actual functionality comes from one or more interchangeable COM objects, which are placed in the ControlForm container. As an example of its polymorphism, the container object is a window asking for database 18 login data entry in one case and database 18 project selection data entry in another. The use of one container to display interchangeable components means that universal container logic and the OK and Cancel buttons do not need to be in each COM component. It also means that if needed, more than one component can be displayed on the same form without also having to specifically create a unique, new form and component.

According to present principles, each system API command preferably returns a value that tells whether the command executed correctly or not, making it possible to parse advanced structures based on a boolean true or false. In addition to the required boolean return value, each command may return a near limitless number of command-specific values. A NET ArrayList structure makes this possible by storing data as a dynamically expandable array of Objects. Objects may be generic NET constructs that allow conversion to any other type.

The ArrayList return structure may be kept in memory only temporarily. For each command executed from an XML script the return structure is replaced by the next command's return structure. This necessitates the saving of any return values to be done immediately after executing a system API command. When executing an advanced system command this process is done automatically. When using a user-defined variable the user can manually store return values from memory to variables.

In some embodiments four ways to declare user-defined variables may be provided. The first is through the system API command AddVariable, which requires both the variable name and value to be placed in the script before run time. Each variable type is stored as a string of characters, and every parameter within every command may be read initially as a string that later can be converted to another type by the current system command or through another system command.

A second way to declare a variable is through the system API command PromptAddVariable, which is similar to AddVariable, but which prompts the user during execution for the variable value. The variable name is still declared within the script and fixed at run time.

A third way to declare a variable is through the system API command AddVarFromMem, which stores a return value based on the specified position in the ArrayList return structure of the previous command. This requires some knowledge of the previous command and the available return structure.

A fourth method for declaring a variable, AddMultipleFromMem, is similar to AddVarFromMem, but allows storage of all return values from the previous command into multiple user-defined variables.

By using either AddVarFromMem or AddMultipleFromMem return values stored temporarily can be kept in memory while the program is running. By using a combination of the above four commands the user can declare and assign variables, read user input into variables and assign variables to the output of another command.

System language-specific commands may include “If”, “For”, and “While”. System API commands can include CopyFolder, DeleteFolder, RenameFolder CopyFile, DeleteFile, RenameFile, ExecuteProgram, AddRegKey, RemoveRegKey, CreateFile, WriteToFile, AddIniSection, RemoveIniSection, AddIniKey, RemoveIniKey, Settings, SetStatus, MsgBox, IsFile, IsDir, IsInFile, IsRegKey, IsRegValue, IsIniSection, IsIniKey, IsNT.

Below are presented so-called “Use Cases”, which represent scripts, without formal XML formatting.

1.1 Create INI Configuration Files
Description Create INI file or files for a given recovery tool
Use Case identifier B1
Author
Date May 1, 2003
Revised
Actors Release Engineer
Pre-conditions FI-% Project name %-PAC File-BOM is locked
Actions (Use AddVarToText after each command)
Run Program to generate INI script files
   open VSMS database
   Query Project (GetProject)
   open FI-project-Pac File BOM (GetBOMData?)
   Assign Pac Files (AutoAssignPACFiles)
   Update multiplie (set all to compressed) (SetARCDCompressed?)
   open Program to generate INI script files
   Generate ARCD recovery media Scripts (GenerateARCDScripts)
   Select Drive to generate files to
   View Scripts (Optional)
Check-in INI configuration files (CheckIn)
Upload to VSMS database (UploadFiles)
Send Release Mail for INI (DumpText)
   Subject=VAIO INI FILES RELEASE NOTIFICATION % project name %
   % phase %
   Project
   PC Model
   Build
   INI File name and unique identifier
   list changes from last build
Post-conditions Tested during PAC File Creation process
Includes Check-In
Upload
Extends
Generalizes

1.2 Create Pac File(s) (Packaged Software)
Description Creates PAC file(s) for software recovery tools
Use Case identifier B2
Author
Date May 1, 2003
Revised
Actors Release Engineer
Pre-conditions INI file(s) created
Actions Copy files to local drive
   Open browser
   Browse to ARCD Scripts directory
   Execute program to copy individual software locally from the network
   (ExecuteProgram)
   Verify files are copied to local drive
Execute program to package each directory (ExecuteProgram)
Check-in PAC File(s) (CheckIn)
Upload to VSMS database (UploadFiles)
Send Release Mail for PAC File(s) (DumpText)
   Subject=VAIO PAC FILES RELEASE NOTIFICATION % project name %
   % phase %
   Project
   PC Model
   Phase
   DMI information
   # PAC Files
   PAC File Names
   Changes from Last Build
   Known Issues
   Special Notes
Post-conditions Must be tested during software download and recovery process
Includes Create INI
Check-In
Upload PAC File(s)
Extends Create-INI
Generalizes

1.3 Create RDVD Recovery Media
Description Creates RDVD(s) for HDD Recovery machines that have DVD drives
Use Case identifier B5
Author
Date May 2, 2003
Revised
Actors Release Engineer
Pre-conditions Pac File(s), INI File(s), and Image File(s) are created
Actions Create PAC File(s)
Create Recovery Partition
Test Recovery Functionality
Copy files to local drive
   Copy P1 Contents Local
      Copy Foundation Image files(s) local
      Delete the Minint Folder
      Copy RDVD Boot files to Local
Create ISO File(s)
Create master RDVD(s)
Test
Check-in RDVD(s)
Turn-in RDVD(s) to Software Librarian
Send Release Mail for RDVD
   Subject=VAIO RDVD FILES RELEASE NOTIFICATION % project name %
   % phase %
   Project
   PC Model
   Phase
   Image Unique identifier
   RDVD Unique identifier
   Recovery partition Unique identifier
   DMI information
   Version
   Media
   Volume Labels
   Changes from Last Build
   Known Issues
   Special Notes
Post ISO File(s)
Post-conditions Must be tested with the correct machine(s), DMI information
Includes Check-In
Post ISO (not created yet)
Extends None
Generalizes None

1.4 Create HRCD Recovery Media
Description Creates HRCD(s) for HDD Recovery machines that do not have DVD drives
Use Case identifier B6
Author
Date May 2, 2003
Revised
Actors Release Engineer
Pre-conditions Pac File(s), INI File(s), and Image File(s) are created
Actions Create PAC File(s)
Create Recovery Partition
Test Recovery Functionality
Create master HRCD(s)
Create ISO File(s)
Test
Check-in HRCD(s)
Turn-in HRCD(s) to Software Librarian
Send Release Mail for HRCD
   Subject=VAIO HRCD FILES RELEASE NOTIFICATION % project name %
   % phase %
   Project
   PC Model
   Phase
   Image Unique identifier
   HRCD Unique identifier
   Recovery Partition Unique identifier
   DMI information
   Version
   Media
   Volume Labels
   Changes from Last Build
   Known Issues
   Special Notes
Post ISO File(s)
Post-conditions Must be tested with the correct machine(s), DMI information
Includes Check-In
Post ISO (not created yet)
Extends None
Generalizes None

1.5 Check-In
Description Check in any item into VSMS database
Use Case identifier S1
Author
Date May 2, 2003
Revised
Actors Release Engineer
Pre-conditions None
Actions Check-in an item
Open VSMS database
   Select Software Release/Submit
      Select Vendor
      Select Component/Release Name
      Click Submit
      Fill in the form completely with all applicable data
   Click Submit
Post-conditions None
Includes None
Extends None
Generalizes None

1.6 Upload to VSMS Database
Description Upload an item to the appropriate locations
Use Case identifier S2
Author
Date May 2, 2003
Revised
Actors Release Engineer
Pre-conditions Item is checked in to VSMS database
Actions Open VSMS database
   Select Software Release/Query
      Select Vendor
      Select Component/Release Name
      Click on the Unique identifier for the Item
      Select view item
      Click on Upload
      Follow on screen prompts
Post-conditions None
Includes None
Extends None
Generalizes None

1.7 Upload ISO File(s)
Description Upload an item to the appropriate locations
Use Case identifier S2
Author
Date May 2, 2003
Revised
Actors Release Engineer
Pre-conditions None
Actions Check-in an item
Open VSMS database
   Select Software Release/Query
      Select Vendor
      Select Component/Release Name
   Click Submit
Post-conditions None
Includes None
Extends None
Generalizes None

While the particular SYSTEM AND METHOD FOR BUILDING SOFTWARE SUITE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A method for assembling a software package for a computer, comprising:
presenting XML constructs to a user;
allowing the user to construct an XML script using the constructs, the script defining contents of the software package;
parsing the script to render C++ software code; and
executing the C++ software code to automatically assemble the contents into the software package.

2. The method of claim 1, wherein the constructs are classes in an object-oriented programming environment.

3. The method of claim 2, comprising presenting at least some classes in a class window on a computer display for selection thereof by a user.

4. The method of claim 1, comprising prompting for information relating at least to an identification of the software package to commence the executing act.

5. A system for automatically assembling at least two software applications into a package for loading thereof onto a computer, comprising:
hierarchical object-oriented means for identifying the applications in a script;
means for parsing the script into executable code; and
means for executing the code to automatically assemble the package.

6. The system of claim 5, wherein the hierarchical object-oriented means is an XML system.

7. The system of claim 6, wherein the executable code is C++.

8. The system of claim 7, wherein the XML system includes means for presenting object classes to a user.

9. The system of claim 8, comprising means for presenting at least some classes in a class window on a computer display for selection thereof by a user.

10. The system of claim 9, comprising means for prompting for information relating at least to an identification of the software package.

11. A software system, comprising:
a model component containing object-oriented application programming interfaces (API) useful for generating a list of software applications;
a controller component communicating with the model component and containing a parser to parse the list into code for execution thereof to automatically assemble the applications into a package; and
a view component communicating with the controller component to present object classes to a user for use thereof in generating the list.

12. The system of claim 11, wherein the list contains storage locations associated with the applications.

13. The system of claim 11, wherein the API are XML-based.

14. The system of claim 13, wherein the code is C+.

15. The system of claim 14, comprising means for presenting at least some classes in a class window on a computer display for selection thereof by a user.

16. The system of claim 15, comprising means for prompting for information relating at least to an identification of the package.
